(19) United States
(12) Patent Application Publication
(10) Pub. No.: US 2024/0182282 A1
(43) Pub. Date: Jun. 6, 2024

(54) HYBRID AUTONOMOUS SYSTEM AND HUMAN INTEGRATION SYSTEM AND METHOD

(71) Applicant: Seegrid Corporation, Pittsburgh, PA (US)

(72) Inventors: Sunny Adak, Pittsburgh, PA (US); Alex Cho, Pittsburgh, PA (US); Andrew DiFurio, Pittsburgh, PA (US); Francine Gemperle, Pittsburgh, PA (US); Atticus Huberts, Pittsburgh, PA (US); Jesse Legg, Pittsburgh, PA (US); Jay Liu, Pittsburgh, PA (US); Stephen Ramusivich, McMurray, PA (US)

(21) Appl. No.: 18/524,217

(22) Filed: Nov. 30, 2023

Related U.S. Application Data
(60) Provisional application No. 63/430,171, filed on Dec. 5, 2022.

(51) Int. Cl. B66F 9/06; B66F 9/075

(52) U.S. Cl. CPC B66F 9/063; B66F 9/07581

(57) ABSTRACT

A system and method are provided that include and/or are configured to analyze performance data of at least one autonomous mobile robot (AMR) and at least one electronically trackable human. This can include providing one or more processors and computer storage devices configured to store and execute human and autonomous robot performance analysis program code that analyzes human performance data and AMR performance data collected and/or generated during human and/or AMR execution of tasks. In some embodiments, such tasks can include, for example, order picking on routes navigated through an environment, such as a warehouse. The system and method can adjust tasking to at least one human and/or at least one autonomous robot, e.g., to improve task efficiency, based the analysis of the human and AMR performance data.

### CROSS REFERENCE TO RELATED APPLICATIONS

The present application claims priority to U.S. Provisional Patent Appl. No. 63/430,171, filed Dec. 5, 2022, entitled Hybrid Autonomous System Enabling and Tracking Human Integration into Automated Material Flow, which is incorporated herein by reference in its entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle-Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); International Application No.: PCT/US23/033818, filed on Sep. 27, 2023, entitled Shared Resource Management System and Method; International Application No.: PCT/US23/079141, filed on Nov. 8, 2023, entitled System And Method For Definition Of A Zone Of Dynamic Behavior With A Continuum Of Possible Actins and Locations Within Same; International Application No.: PCT/US23/078890, filed on Nov. 7, 2023, entitled Method And System For Calibrating A Light-Curtain; International Application No.: PCT/US23/036650, filed on Nov. 2, 2023, entitled System and Method for Optimized Traffic Flow Through Intersections with Conditional Convoying Based on Path Network Analysis; U.S. Provisional Appl. 63/430,184 filed on Dec. 5, 2022, entitled Just in Time Destination Definition and Route Planning; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,190 filed on Dec. 5, 2022, entitled Configuration a System That Handles Uncertainty with Human and Logic Collaboration in a Material Flow Automation Solution; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Pat. No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number 2023/0376030, Published on Nov. 23, 2023, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and autonomous mobile robots (AMRs). In particular, the inventive concepts may be related to systems and methods in the field of systems and methods that utilize mobile robots and humans to perform tasks.

### BACKGROUND

Within increasing numbers and types of environments, autonomous vehicles may travel through areas and/or along pathways that are shared with other vehicles and/or pedestrians. Such other vehicles can include other autonomous vehicles, semi-autonomous vehicles, and/or manually operated vehicles. Autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation. Herein, vehicles that are configured for autonomous navigation are referred to as AMRs.

Multiple AMRs may have access to an environment and both the state of the environment and the state of an AMR are constantly changing. The environment can be within, for example, a warehouse or large storage space or facility and the AMRs can include, but are not limited to, pallet lifts, pallet trucks, and tuggers.

Automation does not exist in isolation, but must be integrated with other operational systems including people. Automation does not always operate without “humans in the loop.” Humans in the loop on automation cannot always be planned or predicted. The integration of human and system inputs to drive automation is not often considered.

In a hybrid human and automation operation, people, software and machines are doing things to maintain material flow. Tracking the actions of all three of these entities is critical to understanding what is happening, e.g., what is working and what is not working, to achieve optimal performance.

A system that can track human actions coincident with robot and software operations would solve some key challenges for optimizing said operations. However, the unpredictability of humans, and unknown unknowns of operation action in a hybrid system make this a difficult task. That is, the environments can have many moving parts, e.g., AMRs, humans, stock, and so forth.

Current systems work fine to track this performance data separately—software, machines, and people in different buckets of data that could be manipulated, merged and analyzed. This is a considerable amount of work and requires data expertise, time, and effort. But such systems do not look at all three as part of a dynamic, interrelated system where efficiency is critical.

### SUMMARY

In accordance with one aspect of the inventive concepts, provided is an An electronic performance-based integration system, comprising: one or more processors and data storage devices; a communications module configured to exchange electronic information with one or more autonomous mobile robots (AMRs) and one or more electronic human devices; and a hybrid autonomous system and human integration program code. The program code is executable to: collect AMR performance data and human performance data, including data from at least one of the AMRs and at least one of the human devices generated while performing at least one task, each task including one or more human functions and one or more AMR functions; and analyze the AMR performance data and human performance data and adjust at least one human function and/or at least one AMR function related to the at least one task based on the analysis.

In various embodiments, the one or more electronic human devices includes a handheld or wearable device configured to transmit at least a portion of the human performance data in real time during human performance of the at least one human function related to the at least one task.

In various embodiments, the human performance data is collected and/or transmitted by the at least one human device during human interaction with the at least one AMR while performing the at least one task.

In various embodiments, the at least one AMR is configured to transmit at least a portion of the AMR performance data in real time during AMR performance of the at least one AMR function related to the at least one task.

In various embodiments, the AMR performance data is collected and/or transmitted by the at least one AMR during AMR interaction with the at least one human while performing the at least one task.

In various embodiments, the hybrid autonomous system and human integration program code is executable to adjust the at least one human function and/or the at least one AMR function to improve efficiency related to performance of the at least one task and/or one or more AMR functions and/or human functions necessary to complete the at least one task.

In various embodiments, the hybrid autonomous system and human integration program code is executable to improve a throughput, reduce a travel distance, reduce a travel time, and/or reduce resources of the at least one AMR and/or the at least one human required to complete the at least one task, the one or more AMR functions, and/or the one or more human functions.

In various embodiments, the hybrid autonomous system and human integration program code is executable to adjust the at least one human function and/or the at least one AMR function related to the at least one task in real or near real time.

In various embodiments, the hybrid autonomous system and human integration program code is executable to adjust route planning for at least one of the human and/or the at least one AMR.

In various embodiments, the hybrid autonomous system and human integration program code is executable to reassign tasks, AMR functions, and/or human functions to at least one other human and/or at least one other AMR.

In accordance with another aspect of the inventive concepts, provided is an electronic performance-based integration method, comprising: providing one or more processors and data storage devices; electronically exchanging information with one or more autonomous mobile robots (AMRs) and one or more electronic human devices; collecting AMR performance data and human performance data, including data from at least one of the AMRs and at least one of the human devices generated while performing at least one task, each task including one or more human functions and one or more AMR functions; and analyzing the AMR performance data and human performance data and adjusting at least one human function and/or at least one AMR function related to the at least one task based on the analysis.

In various embodiments, the method further comprises the one or more electronic human devices including a handheld or wearable device transmitting at least a portion of the human performance data in real time during human performance of the at least one human function related to the at least one task.

In various embodiments, the method further comprises collecting and/or transmitting the human performance data by the at least one human device during human interaction with the at least one AMR while performing the at least one task.

In various embodiments, the method further comprises the at least one AMR transmitting at least a portion of the AMR performance data in real time during AMR performance of the at least one AMR function related to the at least one task.

In various embodiments, the method further comprises collecting and/or transmitting the AMR performance data by the at least one AMR during AMR interaction with the at least one human while performing the at least one task.

In various embodiments, the method further comprises adjusting the at least one human function and/or the at least one AMR function to improve efficiency related to performance of the at least one task and/or one or more AMR functions and/or human functions necessary to complete the at least one task.

In various embodiments, the method further comprises adjusting includes improving a throughput, reduce a travel distance, reduce a travel time, and/or reduce resources of the at least one AMR and/or the at least one human required to complete the at least one task, the one or more AMR functions, and/or the one or more human functions.

In various embodiments, the adjusting includes adjusting the at least one human function and/or the at least one AMR function related to the at least one task in real or near real time.

In various embodiments, the adjusting includes adjusting route planning for at least one of the human and/or the at least one AMR.

In various embodiments, the adjusting includes reassigning tasks, AMR functions, and/or human functions to at least one other human and/or at least one other AMR.

In various embodiments, one or more of the above system features can be combined and one more of the above method features can be combined, in accordance with aspects of the inventive concepts.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of an AMR forklift that may employ systems and methods in accordance with principles of inventive concepts.

FIG. 2 is a block diagram of components of an embodiment of AMR 100 of FIG. 1, in accordance with principles of inventive concepts.

FIG. 3 illustrates a block diagram of an embodiment of a hybrid autonomous system and human integration system, in accordance with aspects of the inventive concepts.

FIG. 4 illustrates an example of an environment with a plurality of AMRs and humans in communication with a hybrid autonomous system and human integration system, in accordance with aspects of inventive concepts.

FIG. 5 illustrates an example of a diagram depicting performance data collection in a hybrid autonomous system and human integration system, in accordance with aspects of inventive concepts.

FIG. 6 illustrates a flow diagram depicting an embodiment of a hybrid autonomous system and human integration method, in accordance with aspects of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspects of the inventive concepts, a task automation solution is provided to track actions of both autonomous systems and human operators conjointly in order to derive performance metrics on man/machine collaboration. The system and method provide hybrid autonomous system and human integration related to task performance. Each task may include functions to be performed by one or more autonomous systems and functions to be performed by one or more humans to achieve collaborative, hybrid task performance. Various embodiments of systems and methods in accordance with the inventive concepts include:
1. Humans can optionally engage with job flows through touchscreen interfaces in the facility (e.g., via handheld device or stationary terminals),
2. Human engagement with the automation is tracked through various input mechanisms,
3. Autonomous robot (e.g., AMR) actions in the system can also be tracked, internal to the automation system (e.g., WMS or FMS),
4. Inside the system, data models exist with shared reporting on human and robot interactions to model task flow in a hybrid system,
5. In various embodiments, works with or without human participation,
6. System set up allows system designers to configure when and how human interactions will occur in the system, and
7. The system offers the ability to analyze the data reported on human and autonomous robot interactions with the task flow system in order to optimize through revisions to the solution design.

This approach can be used to improve efficiency of humans and autonomous robots, thereby improving task flow through the environment. In some embodiments, tasks can include picking of goods and/or objects and the task flow can include material flow.

In various embodiments, this approach allows a hybrid autonomous system to track human integration into automated material flow solutions along with autonomous mobile robot (AMR) performance data and warehouse management system (WMS), fleet management system (FMS), or other warehouse solution data. The hybrid automation system can form part of the WMS/FMS. In various embodiments, the hybrid autonomous system can comprise one or more processors and data storage devices configured to store and execute automated human and autonomous robot performance analysis program code that analyzes various types of data collected during human and autonomous robot execution of tasks. In various embodiments, the tasks can include or be related to order picking using AMRs navigating routes through an environment, such as a warehouse. In other embodiments, the tasks need not include or be related to order picking or could be related to a combination of order picking tasks and other tasks.

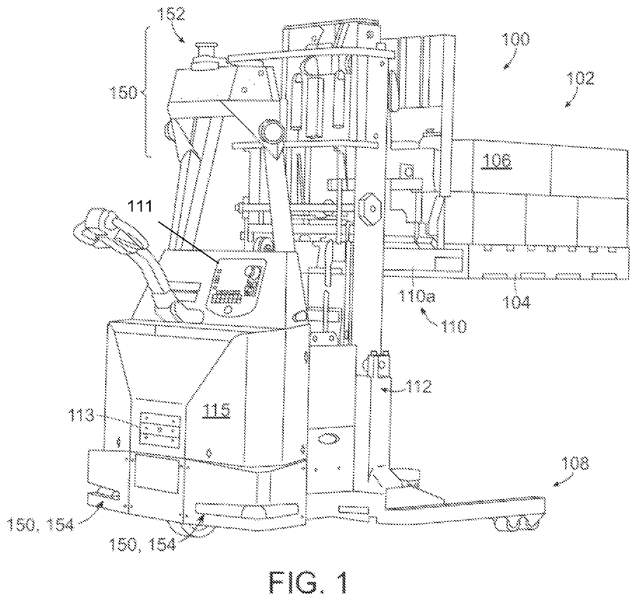

FIG. 1 is a perspective view of an embodiment of an AMR 100 forklift that comprises features described herein, in accordance with aspects of the inventive concepts. In some embodiments, such as the one shown in FIG. 1, the AMR comprises a load engagement portion 110, such as a pair of forks 110a, 110b (not shown). Forks 110 extend from the AMR in a first direction. The AMR is configured to travel in the first direction and, alternatively, in a second direction. The second direction can be considered opposite to the first direction, understanding that the AMRs have turning capability in both directions.

In various embodiments, a user interface can be provided to input route planning information or other task planning information. A user interface (UI) 111 can be provided on the AMR or on a computer that communicates with the AMR, such as a laptop, tablet, phablet, desktop, mobile phone, or other such computer device having a user interface. A “wizard” may be generated at or within the UI to assist a user in inputting information necessary for task and/or route planning, e.g., the wizard user interface can present computer displays that guide a user through entering task and route information.

In some embodiments, for example, aspects of the inventive concepts are configured to work with AMRs made by Seegrid Corporation, such as Seegrid's Palion™ line of AMRs. In some embodiments, aspects of the inventive concepts disclosed herein are configured to work with a warehouse management system (WMS), such as Seegrid Supervisor™, as described in greater detail below. In other embodiments, systems and methods in accordance with the inventive concepts can be implemented with other forms of autonomously navigated vehicles and/or mobile robots and warehouse management systems. In other embodiments, the inventive concepts can be provided in any context where humans and robots collaborate in hybrid task performance.

AMR 100 can be configured with the sensing, processing, and memory devices and subsystems necessary and/or useful for autonomous navigation and task performance, in accordance with aspects of the inventive concepts. In this embodiment, AMR 100 takes the form of an AMR pallet lift, but the inventive concepts could be embodied in any of a variety of other types of robotic vehicles and AMRs, including, but not limited to, pallet trucks, tuggers, and the like, or non-warehouse vehicles.

In this embodiment, AMR 100 includes a payload area 102 configured to transport a pallet 104 loaded with goods 106. To engage and carry the pallet 104, the AMR includes forks 110. Outriggers 108 extend from the robotic vehicle in the direction of the forks to stabilize the vehicle, particularly when carrying the palletized load 106. AMR 100 can comprise a battery area 112 for holding one or more batteries. In various embodiments, the batteries can be configured for charging via a charging interface 113. AMR 100 can also include a main housing 115 within which various control elements and subsystems can be disposed, including those that enable the robotic vehicle to navigate from place to place.

AMR 100 may include a plurality of sensors 150 that provide various forms of sensor data that enable the robotic vehicle to safely navigate throughout an environment, engage with objects to be transported, and avoid obstructions, and otherwise perform tasks. In various embodiments, the sensor data from one or more of the sensors 150 can be used for path adaptation, including avoidance of detected objects, obstructions, hazards, humans, other robotic vehicles, and/or congestion during navigation. Sensors 150 can include one or more cameras, stereo cameras 152, radars, and/or laser imaging, detection, and ranging (LiDAR) scanners 154. One or more of the sensors 150 can form part of a 2D or 3D high-resolution imaging system.

One or more of the sensors 150 can also be used to collect performance data, e.g., AMR performance data and, optionally, human performance data. UI 111 can also be used to collect human performance data. For example, when human enters a task complete input at UI 111, human performance data and AMR performance data, including their locations, can be recorded and/or collected.

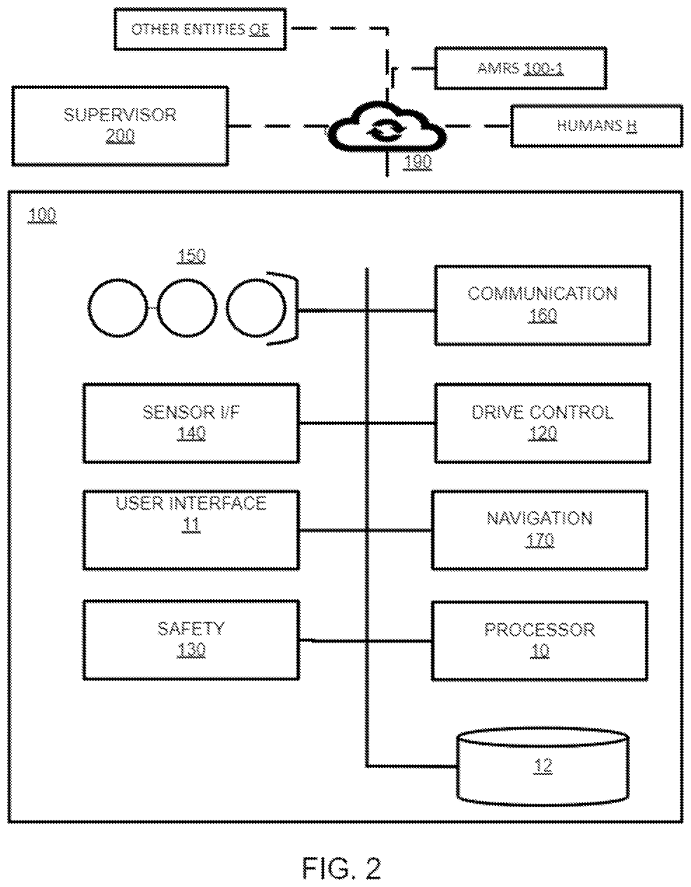

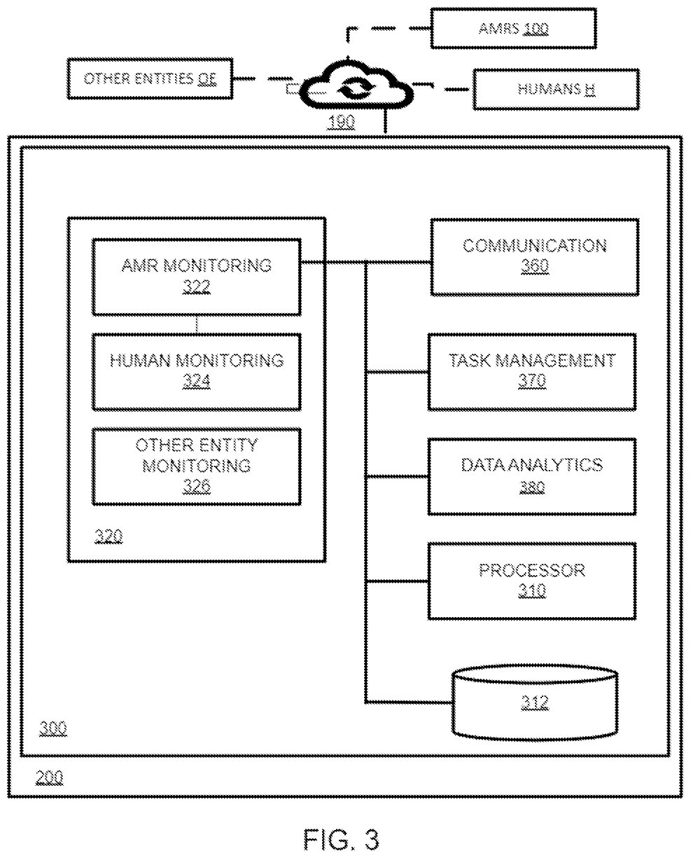

FIG. 2 is a block diagram of components of an embodiment of AMR 100 of FIG. 1, in accordance with principles of inventive concepts. The embodiment of FIG. 2 is an example; other embodiments of a robotic vehicle can include other components and/or terminology. In the example embodiment shown in FIG. 1, AMR 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment, such as humans. Supervisor 200 can be local or remote to the environment, or some combination thereof. An embodiment of aspects of supervisor 200 configured with hybrid autonomous system and human integration functionality is described with respect to FIG. 3.

As shown in FIG. 2, in example embodiments, AMR 100 includes various functional elements, e.g., components and/or modules, which can be housed onboard, e.g., within housing 115. Such functional elements can include at least one processor 10 coupled to at least one memory 12 to cooperatively operate the vehicle and execute its functions or tasks. Memory 12 can include computer program instructions, e.g., in the form of a computer program code or product, executable by processor 10 to perform functions. Memory 12 can also store various types of data and information. Such data and information can include route data, path data, path segment data, pick data, location data, environmental data, and/or sensor data, as examples, as well as the electronic map of the environment. Memory 12 can also store AMR and/or human performance data.

In this embodiment, processor 10 and memory 12 are shown onboard AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across supervisor 200, other vehicles, and/or other systems external to the AMR.

The functional elements of AMR 100 can further include a navigation module 170 configured to access environmental data, such as the electronic map, and path information stored in memory 12, as examples. Navigation module 170 can communicate instructions to a drive control subsystem 120 to cause AMR 100 to navigate its path or route within the environment. During vehicle travel, navigation module 170 may receive information from one or more sensors 150, via a sensor interface (I/F) 140, to control and adjust the navigation of the robotic vehicle. For example, sensors 150 may provide sensor data to navigation module 170 and/or drive control subsystem 120 in response to sensed objects and/or conditions in the environment to control and/or alter the robotic vehicle's navigation. As examples, sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of sensors 150, including LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause drive control subsystem 120 to stop the vehicle to avoid the hazard.

Sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of sensors 150, e.g., one or more stereo cameras 152 and/or LiDAR scanners 154, can be used to generate and/or update a 2-dimensional or 3-dimensional model or map of the environment, and sensor data from one or more of sensors 150 can be used for the determining location of AMR 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In example embodiments, AMR 100 may include a user interface module 11 configured to control UI 111, including generating outputs and processing inputs of the UI 111. A trainer may employ an AMR's user interface 11 to load behaviors as the trainer trains the AMR to perform tasks and execute a path.

In various embodiments, supervisor 200 can be configured to provide instructions to and exchange data with AMR 100, and to monitor the navigation and activity of the AMR and other robotic vehicles 100-1, humans “H,” and other entities “OE,” all of which can be considered assets within the environment. Movements and functions of robotic vehicles, humans, and other entities can be tracked and/or monitored by supervisor 200.

The AMR can include a communication module 160 configured to enable communications with supervisor 200 and/or any other external systems, such as other AMRs 100-1, human's H with electronic devices, and other communication enabled entities OEs. The communication module 160 can include hardware, software, firmware, receivers, and transmitters that enable communication with the supervisor 200 and any other external systems over any now known or hereafter developed communication technology and/or networks, such as various types of wireless technology including, but not limited to, Wi-Fi, Bluetooth, cellular, global positioning system (GPS), radio frequency (RF), and so on (collectively represented as network 190).

As an example, the supervisor 200 could wirelessly communicate a path or route for AMR 100 to navigate for the vehicle to perform a task or series of tasks. The path can be relative to a map of the environment stored in memory and, optionally, updated from time-to-time, e.g., in real-time, from vehicle sensor data collected in real-time as AMR 100 navigates and/or performs its tasks. The sensor data can include sensor data from sensors 150 and/or other sensors in the environment, including sensors associated with supervisor 200, those of other AMRs, and/or humans with electronics devices. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the AMR 100, such as to determine robotic vehicle's location within an environment, battery status and/or fuel level, and/or other operating, vehicle or task performance status and information, and/or load parameters.

FIG. 3 illustrates a block diagram of an embodiment of a hybrid autonomous system and human integration system 300, in accordance with aspects of the inventive concepts. In this embodiment, the system forms part of supervisor system 200. In other embodiments, system 300 could be a standalone system or part of a different system. The system 300 includes at least one processor 310 and at least one computer memory 312. The computer memory can be configured to store computer instructions executable by the processor to perform a hybrid autonomous system and human integration method, in accordance with aspects of the inventive concepts.

System 300 can include a communication module 360 that enables communication via network 190 with AMRs 100, humans H, and/or other entities OE. System 300 can include a monitoring system 320 configured to track and monitor the AMRs 100, humans H, and/or other entities OE via communication module 360 and network 190. In various embodiments, monitoring system 320 can include an AMR monitoring module 322 configured to track and monitor AMRs 100, a human monitoring module 324 configured to track and monitor humans H, and, optionally, an other entity monitoring module 326 configured to track and monitor other entities within the environment. Such other entities could be configured to perform functions related to tasks of the AMRs and humans, provide AMR and/or human performance data, and/or provide environmental data. For example, humans and AMRs may be collaboratively engaged in the performance of one or more planned or predetermined tasks. Their locations and statuses, such as task performance completion and/or resource utilization, may be tracked by monitoring system 320. Other entities could also be involved in functions related to the tasks of an AMR and one or more humans, or in functions related to other tasks that compete for resources needed by the AMR and/or the one or more humans for their task.

System 300 can also include a data analytics module 380 configured to analyze human performance data, AMR performance data, and tasks to be completed and, based thereon, allocate, adjust, and/or reallocate humans and/or AMRs, and/or other entities, for increased efficiency. Optimization and planning module 380 may interface with a task management module 370 that provides task-related data and instructions to the humans, e.g., via handheld, wearable, or other human electronics devices, and/or to the AMRs. Task management module 370 may provide data and instructions that reassign, redirect, or otherwise adjust human and/or AMR task performance and/or functions based on analytics provided by a data analytics module 380.

In various embodiments, data analytics module 380 can apply machine learning and artificial intelligence to model tasks, human performance, and AMR performance and optimize tasks by allocating the humans and AMRs based on such models. For example, human performance data may indicate that different humans perform differently on different tasks and different AMRs, e.g., different models, configurations, and/or units, may perform differently on different tasks. Data analytics module 380 may be configured to learn strengths and weaknesses of humans and AMRs and perform optimization based, at least in part, on such learning. Such optimization can include adjusting the humans and AMRs functions associated with tasks.

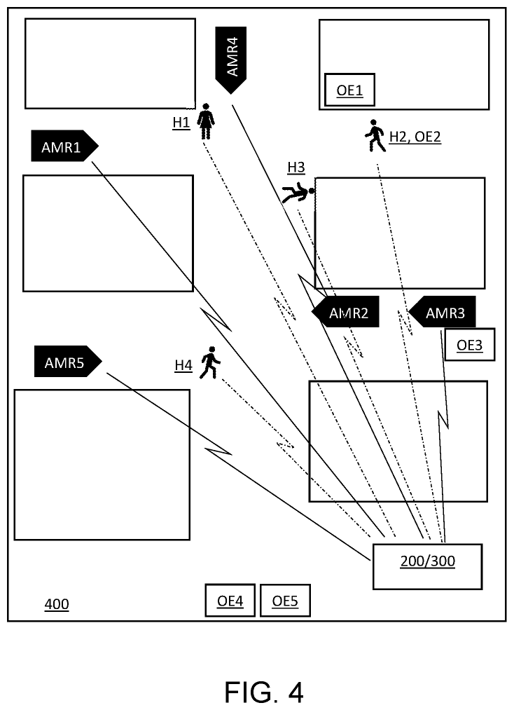

FIG. 4 illustrates an example of an environment having a plurality of entities in communication with a hybrid autonomous system and human integration system 300 configured to enable and track human integration into automated task flow, in accordance with aspects of inventive concepts. In a warehouse environment, the automated task flow can be or include automated material flow. In this embodiment, system 300 forms part of supervisor system 200, as in FIG. 3. While a single supervisor 200/system 300 is shown in FIG. 4, in other embodiments, there could be a plurality of supervisors 200 and/or a plurality of hybrid autonomous system and human integration systems 300.

In FIG. 4, a plurality of AMRs, i.e., AMR1 through AMR5, and humans, i.e., H1 through H5, are operating within the environment and communicate with supervisor 200/system 300. The humans can be equipped with handheld and/or wearable electronic devices that collect human performance data and communicate with supervisor 200/system 300. The humans and AMRs can be collaborating in performance of one or more tasks, each performing one or more functions related to a task. In some embodiments, other entities, such as OE1 through OE5, can also be present in the environment and in communication with supervisor 200/system 300, AMR1-AMR5, and/or humans H1-H5. The other entities can be other systems or processes running on an AMR, an electronic device of a human, the supervisor, or some other system. Such other entities can also be sources of AMR and/or human performance data. For example, other entities in the environment can include systems such as charging stations, other vehicles, kiosks, terminals, or other computers, and/or other human-carried devices. In some embodiments, one or more of the humans, the AMRs, and/or the other entities can communicate directly with each other, as well as or instead of communicating with supervisor 200/system 300 via network 190.

In some embodiments, one or more of the humans can be order pickers that load goods on AMRs at pick locations within a warehouse environment. The humans can be equipped with handheld or wearable communication-enabled electronic devices through which they can communicate with supervisor 200/system 300, AMRs, other humans, and/or other entities. In some embodiments, the humans can communicate via the AMR, such as via UI 111. In some embodiments, one or more humans can be dedicated to an AMR for task performance. In some embodiments, a human can assist a plurality of AMRs with performing different tasks. In some embodiments, the humans can be stationed, at least for a duration of time, in a task performance location, e.g., a pick zone and/or a pick location (or pick face), and load goods onto different AMRs as they navigate through the pick zone and/or to the pick location. In some embodiments, a pick zone can have multiple pick locations. In other embodiments, the tasks could be different and need not be pick or drop tasks, e.g., a maintenance task or other service tasks.

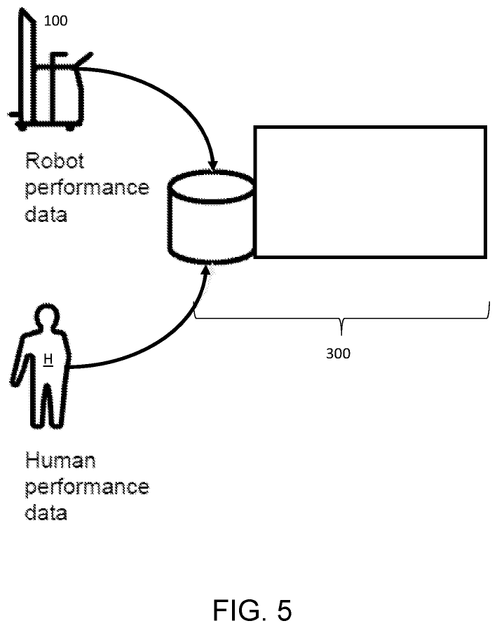

FIG. 5 illustrates an example of a data diagram depicting a hybrid autonomous system and human integration system 300, in accordance with aspects of inventive concepts. As shown in FIG. 5, AMRs 100 can report AMR performance data to the hybrid autonomous system and human integration system 300 and humans H can report human performance data to the hybrid autonomous system and human integration system 300. In various embodiments, the human performance data can be collected and/or transmitted by handheld or wearable electronic devices carried or worn by the human. Additionally, other alternatively, human performance data can be collected and/or transmitted by the UI 111 of the AMR and/or by other entities (OEs) within the environment, such as other AMRs and/or other human electronic devices. In various embodiments, the AMR performance data can be collected and/or transmitted by the AMR. Additionally, or alternatively, the AMR performance data can be collected and/or transmitted by handheld or wearable electronic devices carried or worn by the human and/or by other entities (OEs) within the environment, such as other AMRs and/or other human electronic devices. The performance data can be collected by the monitoring system 320, or its modules 322, 324, 326. The performance data can be “pushed” or “pulled” from the human devices, AMRs, or OEs, or a combination thereof.

In various embodiments, AMR performance data can include any number of types of data that can be determined through analyzing an AMR's navigation data (e.g., time, path, distance, speed) collected while executing functions related to a task, e.g., picking goods from different locations on a pick list. The data can be collected by the AMRs recording their respective navigations and/or by supervisor 200/system 300 monitoring and managing the AMRs. AMR performance data can include or be based on throughput, task execution time, location, route distance, stops and starts, and/or other such data. Throughout can mean the number of tasks completed in a given time. Increasing or improving throughput can mean performing more tasks in the same amount of time or less time. Increasing or improving throughput can mean eliminating one or more human or AMR functions to enable the performance of more tasks in the same amount of time or less time or performing the same task in less time. Improving efficiency can be achieved by improving throughput. Improving efficiency can also be achieved in other ways, such as, for example, by reducing resources needed to accomplish a task or to accomplish AMR and/or human functions needed to complete the task.

In various embodiments, human performance data can include any number of types of data that can be determined though analyzing a human's interaction with a handheld or wearable electronic device, AMRs, terminals within the environment, and/or other sensors or other entities within the environment. Supervisor 200/system 300 can track and monitor the humans' performance data and/or AMR performance data from a plurality of sources that collect and/or transmit data. The human's interaction can be analyzed to determine human navigation data (e.g., time, path, distance, location, speed) collected while the human interacts with one or more AMRs executing a task. Human performance data can include or be based on throughput, task execution time, route distance, stops and starts, location, and/or other such data.

The hybrid autonomous system and human integration system 300, which can form part of supervisor 200, can analyze the human performance data and AMR performance data in real or near real time and adjust at least one human function and/or AMR function associated with at least one task based on the analysis. The performance analysis could be used to improve overall efficiency, as examples, to modify routes of the AMRs and/or humans.

In various embodiments, therefore, adjusting at least one human function and/or the at least one AMR function can be done to improve efficiency related to performance of the at least one task and/or one or more AMR functions and/or human functions necessary to complete the at least one task. Improved efficiency can take the form of shorter time to complete a task or tasks, reduced functions by an AMR and/or human to complete a task, and/or completion of a task or tasks with less resources or in less time, as examples. Such resources can include materials, manpower, time, and/or energy, as examples. In various embodiments, the adjusting to improve efficiency can include improving a throughput, reduce a travel distance, reduce a travel time, and/or reduce resources of the at least one AMR and/or the at least one human required to complete the at least one task, one or more AMR functions, and/or one or more human functions.

In various embodiments, adjusting can include adjusting at least one human function and/or at least one AMR function related to at least one task in real or near real time based, at least in part, on the performance analysis. In various embodiments, adjusting can include adjusting route planning for at least one human and/or at least one AMR based, at least in part, on the performance analysis. In various embodiments, adjusting can include reassigning tasks, AMR functions, and/or human functions to at least one other human and/or at least one other AMR based, at least in part, on the performance analysis.

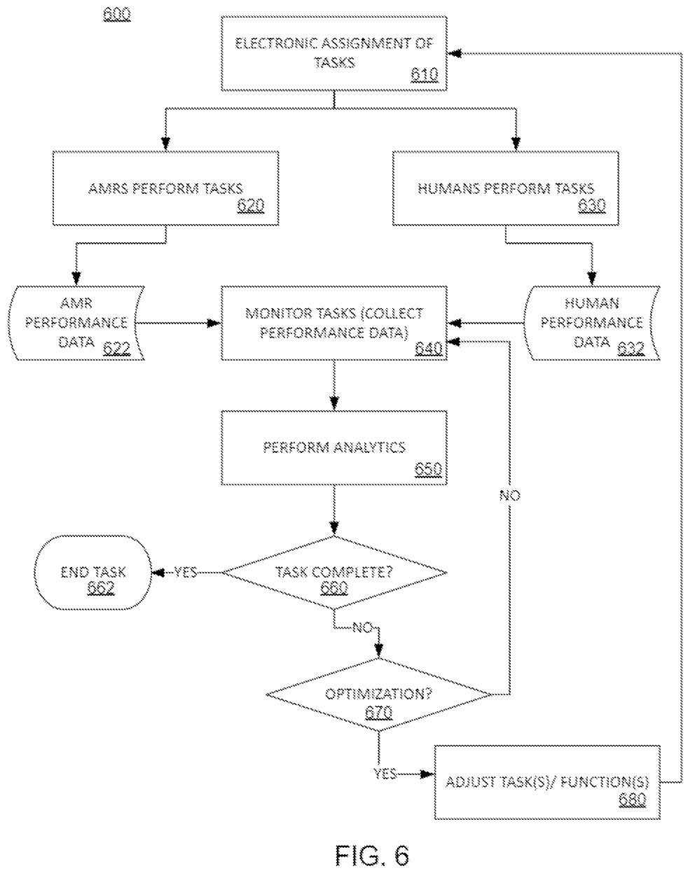

FIG. 6 illustrates a flow diagram depicting an embodiment of a hybrid autonomous system and human integration method 600, in accordance with aspects of inventive concepts. The method 600 may be implemented and/or carried out by the hybrid autonomous system and human integration system 300 described herein.

In step 610, the AMRs and humans are electronically assigned one or more tasks. The assignment could include one or more task locations and an identification of one or more tasks to be performed at the one or more task locations. The task assignments could include navigation instructions and/or a navigation route. The task instructions can be communicated to the AMR electronically via network 190 or via UI 111, or by some other electronic mechanism or system.

In step 620, the AMRs engage in task performance functions. While an AMR performs its task functions, AMR performance data 622 may be generated, collected, and/or transmitted. The AMR performance data can be generated by the AMR and communicated to the system 300 and/or system 300 can collect performance data related to the AMR through monitoring of the AMR's task performance, task function completion, location, progress along it's route, AMR system status data, and/or combinations of two or more thereof, or based on other data related to the task or functions to be performed. AMR performance data could additionally, or alternatively, be generated, collected, and/or transmitted via a human device, other AMRs, and/or other systems or entities within the environment, including monitoring systems.

In step 630, the humans perform their tasks. While a human performs its task functions, human performance data 632 may be generated, collected, and/or transmitted. The human performance data can be generated by an electronic human device, such as an electronic handheld device or wearable device, and communicated to the system 300 and/or system 300 can collect performance data related to the human through electronic monitoring of the human's task performance, task function completion, location, progress along it's route, human device system status data, and/or combinations of two or more thereof, or based on other data related to the task or tasks to be performed. Human performance data could additionally, or alternatively, be generated, collected, and/or transmitted via the AMR interface 111, other AMRs, and/or other systems or entities within the environment, including monitoring systems.

In step 640, monitoring system 320 receives and/or collects the AMR performance data and the human performance data. In various embodiments, at least some of the monitoring can be performed in real time, simultaneously on one or more AMRs and/or one or more human devices. Additionally, or alternatively, in various embodiments, at least some of the monitoring can be performed by intermittent, scheduled, ad hoc, or prompted querying of one or more AMRs and/or one or more human devices. Prompted monitoring can occur when an AMR or a human device outputs a signal of a condition, such as task completed, human input, detected location, an error or malfunction, or low fuel indication, as examples, and that signal is received by system 300.

In step 650, data analytics module 380 analyzes AMR performance data 622 and/or human performance data 632 and, in step 660, determines of an AMR and/or human task or function is complete. If the task is complete, the method transitions to step 662, end task. If in step 660 it is determined that the AMR and/or human task or function is not complete the method transitions to step 670 to determine if, based on the AMR and human performance data, optimization of the task or functions is possible. If the answer is NO, the method reverts to step 640 where monitoring continues. If in step 670 the answer is YES, the method transitions to step 680 where the task management module 370 adjusts (or optimizes) one or more tasks or task functions of a human and/or an AMR. The method then transitions back to step 610 where the adjusted (or optimized) tasks are communicated to the appropriate AMR or AMRs and/or human or humans. Optimization of a task or task function, whether a human task or function or an AMR task function my include modifying, adding, or deleting a task on a list of tasks, a location, a route or path, and/or a task function.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

Below follows an itemized list of statements describing embodiments in accordance with the inventive concepts:
1. An electronic performance-based integration system, comprising:
one or more processors and data storage devices;
a communications module configured to exchange electronic information with one or more autonomous mobile robots (AMRs) and one or more electronic human devices; and
a hybrid autonomous system and human integration program code that, when executed, is configured to:
collect AMR performance data and human performance data, including data from at least one of the AMRs and at least one of the human devices generated while performing at least one task, each task including one or more human functions and one or more AMR functions; and
analyze the AMR performance data and human performance data and adjust at least one human function and/or at least one AMR function related to the at least one task based on the analysis.
2. The system of statement 1, or any other statement or combinations of statements, wherein the one or more electronic human devices includes a handheld or wearable device configured to transmit at least a portion of the human performance data in real time during human performance of the at least one human function related to the at least one task.
3. The system of statement 1, or any other statement or combinations of statements, wherein the human performance data is collected and/or transmitted by the at least one human device during human interaction with the at least one AMR while performing the at least one task.
4. The system of statement 1, or any other statement or combinations of statements, wherein the at least one AMR is configured to transmit at least a portion of the AMR performance data in real time during AMR performance of the at least one AMR function related to the at least one task.
5. The system of statement 1, or any other statement or combinations of statements, wherein the AMR performance data is collected and/or transmitted by the at least one AMR during AMR interaction with the at least one human while performing the at least one task.
6. The system of statement 1, or any other statement or combinations of statements, wherein the hybrid autonomous system and human integration program code is executable to adjust the at least one human function and/or the at least one AMR function to improve efficiency related to performance of the at least one task and/or one or more AMR functions and/or human functions necessary to complete the at least one task.
7. The system of statement 6, or any other statement or combinations of statements, wherein the hybrid autonomous system and human integration program code is executable to improve a throughput, reduce a travel distance, reduce a travel time, and/or reduce resources of the at least one AMR and/or the at least one human required to complete the at least one task, the one or more AMR functions, and/or the one or more human functions.
8. The system of statement 1, or any other statement or combinations of statements, wherein the hybrid autonomous system and human integration program code is executable to adjust the at least one human function and/or the at least one AMR function related to the at least one task in real or near real time.
9 The system of statement 1, or any other statement or combinations of statements, wherein the hybrid autonomous system and human integration program code is executable to adjust route planning for at least one of the human and/or the at least one AMR.
10. The system of statement 1, or any other statement or combinations of statements, wherein the hybrid autonomous system and human integration program code is executable to reassign tasks, AMR functions, and/or human functions to at least one other human and/or at least one other AMR.
11. An electronic performance-based integration method, comprising:
providing one or more processors and data storage devices;
electronically exchanging information with one or more autonomous mobile robots (AMRs) and one or more electronic human devices;
collecting AMR performance data and human performance data, including data from at least one of the AMRs and at least one of the human devices generated while performing at least one task, each task including one or more human functions and one or more AMR functions; and analyzing the AMR performance data and human performance data and adjusting at least one human function and/or at least one AMR function related to the at least one task based on the analysis.
12. The method of statement 11, or any other statement or combinations of statements, further comprising the one or more electronic human devices including a handheld or wearable device transmitting at least a portion of the human performance data in real time during human performance of the at least one human function related to the at least one task.
13. The method of statement 11, or any other statement or combinations of statements, further comprising collecting and/or transmitting the human performance data by the at least one human device during human interaction with the at least one AMR while performing the at least one task.
14. The method of statement 11, or any other statement or combinations of statements, further comprising the at least one AMR transmitting at least a portion of the AMR performance data in real time during AMR performance of the at least one AMR function related to the at least one task.
15. The method of statement 11, or any other statement or combinations of statements, further comprising collecting and/or transmitting the AMR performance data by the at least one AMR during AMR interaction with the at least one human while performing the at least one task.
16. The method of statement 11, or any other statement or combinations of statements, further comprising adjusting the at least one human function and/or the at least one AMR function to improve efficiency related to performance of the at least one task and/or one or more AMR functions and/or human functions necessary to complete the at least one task.
17. The method of statement 16, or any other statement or combinations of statements, wherein the adjusting includes improving a throughput, reduce a travel distance, reduce a travel time, and/or reduce resources of the at least one AMR and/or the at least one human required to complete the at least one task, the one or more AMR functions, and/or the one or more human functions.
18. The method of statement 11, or any other statement or combinations of statements, wherein the adjusting includes adjusting the at least one human function and/or the at least one AMR function related to the at least one task in real or near real time.
19. The method of statement 11, or any other statement or combinations of statements, wherein the adjusting includes adjusting route planning for at least one of the human and/or the at least one AMR.
20 The method of statement 11, or any other statement or combinations of statements, wherein the adjusting includes reassigning tasks, AMR functions, and/or human functions to at least one other human and/or at least one other AMR.

What is claimed is:

1. An electronic performance-based integration system, comprising:
one or more processors and data storage devices;
a communications module configured to exchange electronic information with one or more autonomous mobile robots (AMRs) and one or more electronic human devices; and
a hybrid autonomous system and human integration program code that, when executed, is configured to:
collect AMR performance data and human performance data, including data from at least one of the AMRs and at least one of the human devices generated while performing at least one task, each task including one or more human functions and one or more AMR functions; and
analyze the AMR performance data and human performance data and adjust at least one human function and/or at least one AMR function related to the at least one task based on the analysis.

2. The system of claim 1, wherein the one or more electronic human devices includes a handheld or wearable device configured to transmit at least a portion of the human performance data in real time during human performance of the at least one human function related to the at least one task.

3. The system of claim 1, wherein the human performance data is collected and/or transmitted by the at least one human device during human interaction with the at least one AMR while performing the at least one task.

4. The system of claim 1, wherein the at least one AMR is configured to transmit at least a portion of the AMR performance data in real time during AMR performance of the at least one AMR function related to the at least one task.

5. The system of claim 1, wherein the AMR performance data is collected and/or transmitted by the at least one AMR during AMR interaction with the at least one human while performing the at least one task.

6. The system of claim 1, wherein the hybrid autonomous system and human integration program code is executable to adjust the at least one human function and/or the at least one AMR function to improve efficiency related to performance of the at least one task and/or one or more AMR functions and/or human functions necessary to complete the at least one task.

7. The system of claim 6, wherein the hybrid autonomous system and human integration program code is executable to improve a throughput, reduce a travel distance, reduce a travel time, and/or reduce resources of the at least one AMR and/or the at least one human required to complete the at least one task, the one or more AMR functions, and/or the one or more human functions.

8. The system of claim 1, wherein the hybrid autonomous system and human integration program code is executable to adjust the at least one human function and/or the at least one AMR function related to the at least one task in real or near real time.

9. The system of claim 1, wherein the hybrid autonomous system and human integration program code is executable to adjust route planning for at least one of the human and/or the at least one AMR.

10. The system of claim 1, wherein the hybrid autonomous system and human integration program code is executable to reassign tasks, AMR functions, and/or human functions to at least one other human and/or at least one other AMR.

11. An electronic performance-based integration method, comprising:
providing one or more processors and data storage devices;
electronically exchanging information with one or more autonomous mobile robots (AMRs) and one or more electronic human devices;
collecting AMR performance data and human performance data, including data from at least one of the AMRs and at least one of the human devices generated while performing at least one task, each task including one or more human functions and one or more AMR functions; and
analyzing the AMR performance data and human performance data and adjusting at least one human function and/or at least one AMR function related to the at least one task based on the analysis.

12. The method of claim 11, further comprising the one or more electronic human devices including a handheld or wearable device transmitting at least a portion of the human performance data in real time during human performance of the at least one human function related to the at least one task.

13. The method of claim 11, further comprising collecting and/or transmitting the human performance data by the at least one human device during human interaction with the at least one AMR while performing the at least one task.

14. The method of claim 11, further comprising the at least one AMR transmitting at least a portion of the AMR performance data in real time during AMR performance of the at least one AMR function related to the at least one task.

15. The method of claim 11, further comprising collecting and/or transmitting the AMR performance data by the at least one AMR during AMR interaction with the at least one human while performing the at least one task.

16. The method of claim 11, further comprising adjusting the at least one human function and/or the at least one AMR function to improve efficiency related to performance of the at least one task and/or one or more AMR functions and/or human functions necessary to complete the at least one task.

17. The method of claim 16, wherein the adjusting includes improving a throughput, reduce a travel distance, reduce a travel time, and/or reduce resources of the at least one AMR and/or the at least one human required to complete the at least one task, the one or more AMR functions, and/or the one or more human functions.

18. The method of claim 11, wherein the adjusting includes adjusting the at least one human function and/or the at least one AMR function related to the at least one task in real or near real time.

19. The method of claim 11, wherein the adjusting includes adjusting route planning for at least one of the human and/or the at least one AMR.

20. The method of claim 11, wherein the adjusting includes reassigning tasks, AMR functions, and/or human functions to at least one other human and/or at least one other AMR.
